(19) United States
(12) Patent Application Publication
(10) Pub. No.: US 2009/0071007 A1
(43) Pub. Date: Mar. 19, 2009

(54) Safety razor with enhanced shaving aid member having protuberances

(75) Inventor: Michael Hal Bruno, Burlington, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Gillette Company

(21) Appl. No.: 11/901,005

(22) Filed: Sep. 14, 2007

(51) Int. Cl. B26B 19/42; B26B 21/00; B26B 21/14

(52) U.S. Cl. 30/34.2; 30/77; 30/84

(57) ABSTRACT

A safety razor blade unit is provided. The safety razor blade unit includes at least one elongate blade and a shaving aid member. The shaving aid member extends longitudinally of the blade(s) and has a skin contacting surface exposed for contact with a skin of a user during shaving. The shaving aid member includes a multiplicity of protuberances. Each of the protuberances have a base portion at the skin contacting surface and are defined by side wall portions extending away from the skin contacting surface.

### FIELD OF THE INVENTION

This invention relates to shaving devices and concerns a safety razor blade unit having at least one blade with a cutting edge which is moved across the surface of the skin being shaved by means of a handle to which the blade unit is attached. The blade unit may be mounted detachably on the handle to enable the blade unit to be replaced by a fresh blade unit when blade sharpness has diminished to an unsatisfactory level, or it may be attached permanently to the handle with the intention that the entire razor be discarded when the blade or blades have become dulled. Razor blade units generally include a shaving aid from which a lubricant is very gradually leached out during shaving. The present invention is especially concerned with the shaving aid of a razor blade unit.

### BACKGROUND OF THE INVENTION

As a preliminary step prior to shaving it is common to apply a shaving preparation to the skin to facilitate the shaving operation. One effect of the shaving preparation, for example, is to lubricate the skin to enable the razor to slide more easily over the skin. In some situations, however, the skin is not prepared as well as it might be. Furthermore, at the end of shaving most of the preparation will have been removed. Therefore, it can be advantageous to provide the razor with a means for delivering a shaving enhancement composition or medium during shaving. Thus, it is known to provide a blade unit with a strip of material from which a lubricant is very gradually leached out during shaving. The benefits of such a lubricating strip have been well proven, but the rate at which the lubricant is discharged is too low. Thus, there remains a need for a razor adapted to leach a lubricant from a lubricating strip at a higher rate.

### SUMMARY OF THE INVENTION

According to the present invention there is provided a safety razor blade unit comprising at least one elongate blade and a shaving aid member extending longitudinally of the blade(s). The shaving aid member has a skin contacting surface exposed for contact with a skin of a user during shaving. The shaving aid member comprises a multiplicity of protuberances. Each of the protuberances has a base portion at the skin contacting surface and is defined by side wall portions extending away from the skin contacting surface.

The protuberances may be distributed along the skin contacting surface and across a width thereof in a plurality of generally longitudinally extending rows forming an array. The protuberances may span substantially the whole of the area of the skin contacting surface.

The protuberances may have smoothly curved side walls. Preferably, the protuberances are partially spherical having constantly curving sidewalls.

The protuberances may have any suitable dimension

The distance between adjacent protuberances may be less than 50% of the maximum transverse dimension of the protuberances.

There may be at least two longitudinally extending rows of protuberances. There may be any number of longitudinally extending rows of protuberances.

The shaving aid member may occupy a position of a guard surface in advance of the at least one blade. The shaving aid member may occupy a position of a cap surface behind the at least one blade. The shaving aid member may surround the at least one blade.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a cut away perspective view of a razor blade unit according to the invention;

FIG. 2 is a transverse cross section through the razor blade unit of FIG. 1.

FIG. 3 is a cut away perspective view of another razor blade unit according to the present invention.

FIG. 4 is a perspective view of another razor blade unit according to the present invention.

### DETAILED DESCRIPTION OF THE INVENTION

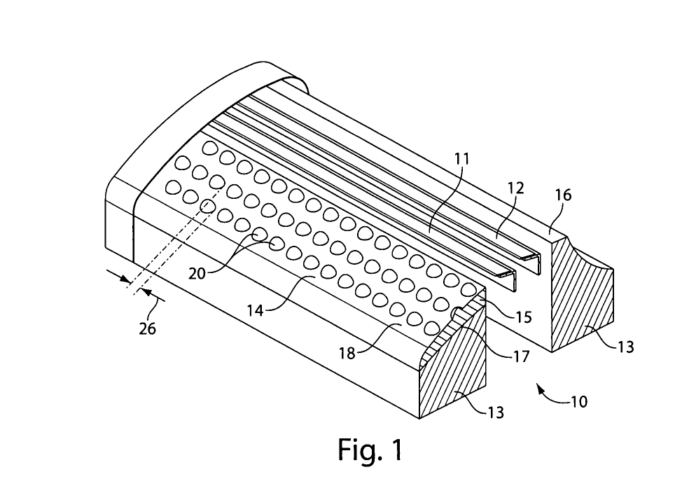

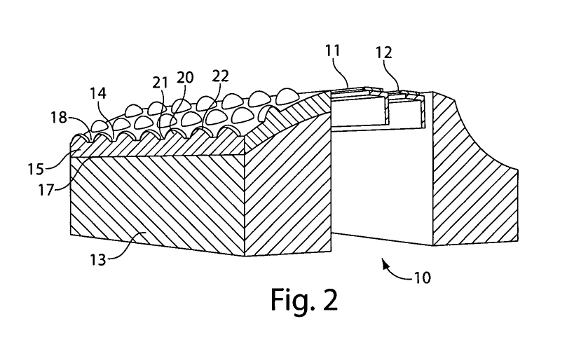

Referring now to FIGS. 1 and 2, safety razor blade unit 10 comprises a pair of blades 11, 12 mounted in tandem in a supporting frame 13. The razor blade unit 10 also comprises a guard 14 in the form of shaving aid member 15 secured to the frame 13 located in front of the blades 11, 12 and a cap 16 located behind the blades 11, 12.

The shaving aid member 15 includes a lower or hidden surface 17 facing supporting frame 13 and an upper, exposed or skin contacting surface 18. The skin contacting surface 18 of the shaving aid member 15 is exposed for contact with a skin of a user during shaving. The lower surface 17 of shaving aid member 15 is secured to frame 13. The shaving aid member 15 may be secured to frame 13 either directly or indirectly. The shaving aid member 15 extends longitudinally of the blades 11, 12. Within shaving aid member 15 is formed a multiplicity of protuberances 20 positioned in a regular array extending over the length and width of the skin contacting surface 18. The protuberances 20 are disposed in a plurality of longitudinal rows, and in the shown example there are three rows with the protuberances 20 in adjacent rows longitudinally off set to permit the protuberances 20 to be closely spaced. The protuberances may be disposed in any number of rows such as two, three, four, five or more. The protuberances 20 have a circular base portion configuration at the skin contacting surface 18. In the illustrated embodiment the protuberances 20 all have the same dimension. The protuberances as shown in FIG. 1 may overlap, as indicated by spacing 26, viewed from a direction transverse to the longitudinal extent of the rows, by which protuberances 20 of one row appear to be partially behind adjacent protuberances of the adjacent row. The overlap results from a relative longitudinal offset between adjacent rows of less than a full protuberances maximum transverse dimension (e.g. diameter).

The protuberances 20 are preferably disposed in an array with sufficient density of packing to ensure satisfactory leaching of product during shaving. A width of surface between the adjacent protuberances 20 of 5% to 100% of the maximum transverse dimensions of the protuberances 20 should be adequate while retaining a sufficiently well defined skin contacting surface.

The protuberances 20 span substantially the whole of the area of the skin contacting surface 18 of the shaving aid member 15. Alternatively, protuberances 20 may span a portion of the area of the skin contacting surface 18 of the shaving aid member 15.

The protuberances 20 have a base portion 21 at the skin contacting surface 18. In a preferred construction the protuberances 20 are partially spherical having constantly curving side walls 22 extending away from the skin contacting surface 18. Other cross sectional shapes such as hexagonal, oval or elliptical are also possible. The protuberances may be circular in cross sectional shape and cylindrical. The height of the protuberances may be any suitable dimension. In the example shown in FIGS. 1 and 2, the height of the protuberances 20 is less than the protuberances 20 diameter, e.g. approximately equal to the protuberance radius, and the amount of material between adjacent protuberances may be less than the protuberance radius.

In the embodiment shown in FIGS. 1 and 2, the shaving aid member 15 occupies a position of a guard surface in advance of the blades 11, 12.

The shaving aid member 15 preferably has lubricating properties, but it may have, either alternatively or in addition, other properties, e.g., moisturizing properties considered beneficial during shaving. The shaving aid member 15 will have adequate leaching properties allowing it to be dispensed during shaving, e.g. upon being made more fluid by contact with water, when the skin contacting surface 18 slides over the skin during shaving.

The shaving aid member 15 preferably comprises a water-soluble shaving aid mixed with a non-water-soluble material to form an insoluble polymer/soluble shaving aid composite. Upon exposure to water, the water-soluble shaving aid leaches from the composite onto the skin. Suitable water-insoluble matrix materials include, for example, polyethylene, polypropylene, polystyrene and polyacetyl. Suitable water-soluble shaving aid materials include, for example, polyethylene oxide, polyvinyl pyrrolidone, polyacrylamide, hydroxypropyl cellulose, polyvinyl imidazonline, polyhydroxyethylmethacrylate, silicone copolymers, sucrose stearate, vitamin E, panthenol, aloe and essential oils such as menthol.

The shaving aid member may also comprise a release-enhancing agent. Suitable release-enhancing agents include, for example, polyethylene glycol, methoxypolyethylene glycol, methylcellulose, and carboxypolymethylene.

The protuberances 20 increase the overall surface area of the shaving aid member 15 allowing for an effective increase in the rate at which shaving aid material leaches from the shaving aid member 15 without altering the properties of the shaving aid material itself. Thus, properties such as moisturizing and lubricating remain unaffected while the effective rate of leaching of the shaving aid member 15 is increased by the addition of protuberances 20.

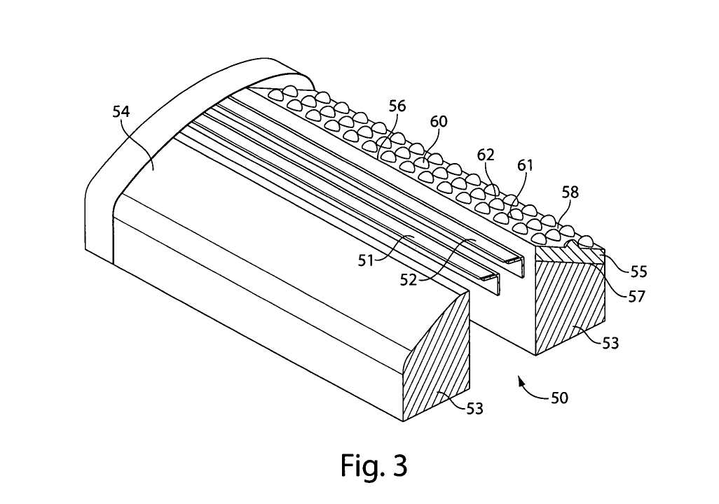

Referring now to FIG. 3, safety razor blade unit 50 comprises a pair of blades 51, 52 mounted in tandem in a supporting frame 53. The razor blade unit 50 also comprises a guard 54 located in front of blades 51, 52 and a cap 56 located behind blades 51, 52 in the form of shaving aid member 55 secured to frame 53.

The shaving aid member 55 includes a lower or hidden surface 57 facing supporting frame 53 and an upper, exposed or skin contacting surface 58. The skin contacting surface 58 of the shaving aid member 55 is exposed for contact with a skin of a user during shaving. The lower surface 57 of shaving aid member 55 is secured to frame 53. The shaving aid member 55 may be secured to frame 53 either directly or indirectly. The shaving aid member 55 extends longitudinally of the blades 51, 52. Within shaving aid member 55 is formed a multiplicity of protuberances 60 positioned in a regular array extending over the length and width of the skin contacting surface 58. The protuberances 60 are disposed in a plurality of longitudinal rows, and in the shown example there are two rows with the protuberances 60 in adjacent rows longitudinally off set to permit the protuberances 60 to be closely spaced. The protuberances 60 are of a partially spherical configuration and in the illustrated embodiment all have the same dimension.

The protuberances 60 are preferably disposed in an array with sufficient density of packing to ensure satisfactory leaching of product during shaving. A width of surface between the adjacent protuberances 20 of 5% to 100% of the maximum transverse dimensions of the protuberances 60 should be adequate while retaining a sufficiently well defined skin contacting surface.

The protuberances 60 span substantially the whole of the area of the skin contacting surface 58 of the shaving aid member 55. Alternatively, protuberances 60 may span a portion of the area of the skin contacting surface 58 of the shaving aid member 55.

The protuberances 60 have a base portion 61 at the skin contacting surface 58. In a preferred construction the protuberances 60 are partially spherical having constantly curving side walls 62 extending away from the skin contacting surface 58. Other cross sectional shapes such as hexagonal, oval or elliptical are also possible. The protuberances may be circular in cross sectional shape and cylindrical. The height of the protuberances may be any suitable dimension. In the example shown in FIG. 3, the height of the protuberances 60 is less than the protuberances 60 diameter, e.g. approximately equal to the protuberance radius, and the amount of material between adjacent protuberances may be less than the protuberance radius.

In the embodiment shown in FIG. 3 the shaving aid member 55 occupies a position of a cap surface behind blades 51, 52.

The shaving aid member 55 preferably has lubricating properties, but it may have, either alternatively or in addition, other properties, e.g., moisturizing properties considered beneficial during shaving. The shaving aid member 55 will have adequate leaching properties allowing it to be dispensed during shaving, e.g. upon being made more fluid by contact with water, when the skin contacting surface 58 slides over the skin during shaving.

The shaving aid member 55 preferably comprises a water-soluble shaving aid mixed with a non-water-soluble material to form an insoluble polymer/soluble shaving aid composite. Upon exposure to water, the water-soluble shaving aid leaches from the composite onto the skin. Suitable water-insoluble matrix materials include, for example, polyethylene, polypropylene, polystyrene and polyacetyl. Suitable water-soluble shaving aid materials include, for example, polyethylene oxide, polyvinyl pyrrolidone, polyacrylamide, hydroxypropyl cellulose, polyvinyl imidazonline, polyhydroxyethylmethacrylate, silicone copolymers, sucrose stearate, vitamin E, panthenol, aloe and essential oils such as menthol.

The shaving aid member may also comprise a release-enhancing agent. Suitable release-enhancing agents include, for example, polyethylene glycol, methoxypolyethylene glycol, methylcellulose, and carboxypolymethylene.

The protuberances 60 increase the overall surface area of the shaving aid member 55 allowing for an effective increase in the rate at which shaving aid material leaches from the shaving aid member 55 without altering the properties of the shaving aid material itself. Thus, properties such as moisturizing and lubricating remain unaffected while the effective rate of leaching of the shaving aid member 55 is increased by the addition of protuberances 60.

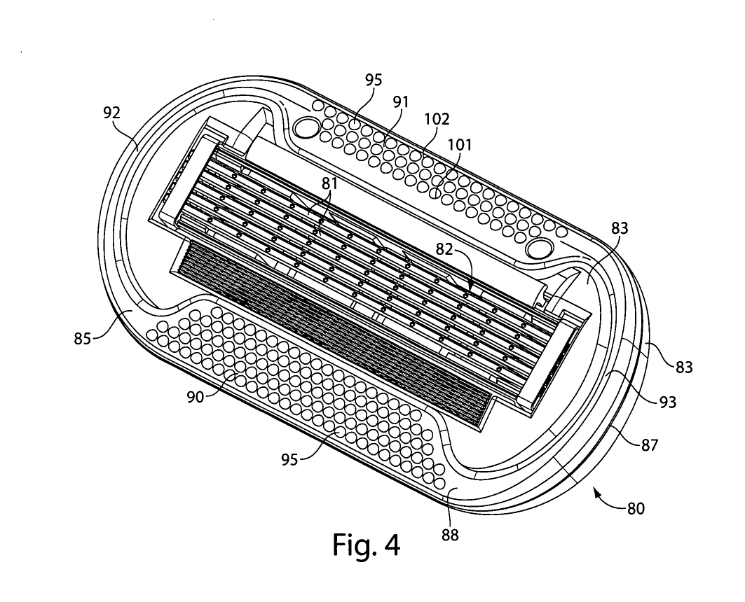

Referring now to FIG. 4, safety razor blade unit 80 comprises five blades 81 mounted in housing 82. Housing 82 is secured to supporting frame 83. The razor blade unit 80 also comprises a shaving aid member 85 secured to frame 83. Shaving aid member 85 surrounds blades 81.

The shaving aid member 85 includes a lower or hidden surface 87 facing supporting frame 83 and an upper, exposed or skin contacting surface 88. The skin contacting surface 88 of the shaving aid member 85 is exposed for contact with a skin of a user during shaving. The lower surface 87 of shaving aid member 85 is secured to frame 83. The shaving aid member 85 may be secured to frame 83 either directly or indirectly. The shaving aid member 85 surrounds blades 81. The shaving aid member 85 includes a guard portion 90 located in front of blades 81, a cap portion 91 located behind blades 81, and two side portions 92, 93 extending between and connecting guard portion 90 with cap portion 91. Guard portion 90 and cap portion 91 of shaving aid member 85 extend longitudinally of the blades 81. Within the guard portion 90 and the cap portion 91 of shaving aid member 85 is formed a multiplicity of protuberances 95. The protuberances 95 extend over the length and width of the skin contacting surface 88 of the guard portion 90 and the cap portion 91. The protuberances 95 in the guard portion 90 are disposed in a plurality of longitudinal rows, and in the shown example there are five rows. The protuberances in the cap portion 91 are disposed in three longitudinal rows. The protuberances 95 are of partially spherical configuration and in the illustrated embodiment all have the same dimension.

The protuberances 95 are preferably disposed in a sufficient density of packing to ensure satisfactory leaching of product during shaving.

The protuberances 95 span a portion of the area of the skin contacting surface 88 of the shaving aid member 85. In the example shown, the protuberances are located in the guard portion 90 and cap portion 91 but are absent from the side portions 92, 93. Alternatively, it maybe desirable to located protuberances in one or both side portions 92, 93.

The protuberances 95 have a base portion 101 at the skin contacting surface 88. The protuberances 95 are partially spherical having constantly curving side walls 102 extending outward from the skin contacting surface 88. Other shapes for protuberances 95 are also possible.

The protuberances 95 may have any suitable dimension.

The shaving aid member 85 preferably has lubricating properties, but it may have, either alternatively or in addition, other properties, e.g., moisturizing properties considered beneficial during shaving. The shaving aid member 85 will have adequate leaching properties allowing it to be dispensed during shaving, e.g. upon being made more fluid by contact with water, when the skin contacting surface 88 slides over the skin during shaving.

The shaving aid member 85 preferably comprises a water-soluble shaving aid mixed with a non-water-soluble material to form an insoluble polymer/soluble shaving aid composite. Upon exposure to water, the water-soluble shaving aid leaches from the composite onto the skin. Suitable water-insoluble matrix materials include, for example, polyethylene, polypropylene, polystyrene and polyacetyl. Suitable water-soluble shaving aid materials include, for example, polyethylene oxide, polyvinyl pyrrolidone, polyacrylamide, hydroxypropyl cellulose, polyvinyl imidazonline, polyhydroxyethylmethacrylate, silicone copolymers, sucrose stearate, vitamin E, panthenol, aloe and essential oils such as menthol.

The shaving aid member may also comprise a release-enhancing agent. Suitable release-enhancing agents include, for example, polyethylene glycol, methoxypolyethylene glycol, methylcellulose, and carboxypolymethylene.

The protuberances 95 increase the overall surface area of the shaving aid member 85 allowing for an effective increase in the rate at which shaving aid material leaches from the shaving aid member 85 without altering the properties of the shaving aid material itself. Thus, properties such as moisturizing and lubricating remain unaffected while the effective rate of leaching of the shaving aid member 85 is increased by the addition of protuberances 95.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A safety razor blade unit comprising
at least one elongate blade, and
a shaving aid member extending longitudinally of the blade(s) and having a skin contacting surface exposed for contact with a skin of a user during shaving, said shaving aid member comprising
a multiplicity of protuberances, each of said protuberances having a base portion at the skin contacting surface and being defined by side wall portions extending away from the skin contacting surface.

2. The safety razor blade unit according to claim 1 wherein said protuberances are distributed along the skin contacting surface and across a width thereof in a plurality of generally longitudinally extending rows forming an array.

3. The safety razor blade unit according to claim 2 wherein said protuberances span substantially the whole of the area of the skin contacting surface.

4. The safety razor blade unit according to claim 1 wherein the protuberances are partially spherical.

5. The safety razor blade unit according to claim 1 wherein the protuberances have a height not greater than a protuberances diameter.

6. The safety razor blade unit according to claim 1 wherein the protuberances have height at least about 50% of the maximum transverse dimension of the protuberances.

7. The safety razor blade unit according to claim 1 wherein the protuberances have height not greater than the maximum transverse dimension of the protuberances.

8. The safety razor blade unit according to claim 1 wherein the distance between adjacent protuberances is less than 50% of the maximum transverse dimension of the protuberances.

9. The safety razor blade unit according to claim 1 wherein there are at least two longitudinally extending rows of protuberances.

10. The safety razor blade unit according to claim 1 wherein the shaving aid member occupies a position of a guard surface in advance of the at least one blade.

11. The safety razor blade unit according to claim 1 wherein the shaving aid member occupies a position of a cap surface behind the at least one blade.

12. The safety razor blade unit according to claim 1 wherein the shaving aid member surrounds the at least one blade.
